(19) United States
(12) Patent Application Publication
(10) Pub. No.: US 2003/0142208 A1
(43) Pub. Date: Jul. 31, 2003

(54) Image reading apparatus

(75) Inventor: Yoichi Nakamura, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/351,435

(22) Filed: Jan. 27, 2003

(30) Foreign Application Priority Data
Jan. 28, 2002 (JP) 2002-17918

(51) Int. Cl. H04N 5/30

(52) U.S. Cl. 348/96; 348/162; 382/319

(57) ABSTRACT

An image reading apparatus includes a light source for irradiating light to an original image, a photoelectric transducing device for detecting reflected or transmitted quantities of the irradiated light, and for transducing the light into an electric signal, and a control mechanism for adjusting an emission region of the light source to a size of the original image. The light source includes a surface-emitting electroluminescent device that emits light of wavelengths corresponding to at least the three primary colors.

### BACKGROUND OF THE INVENTION

1. Field of the Invention

The present invention relates to an image reading apparatus that irradiates an original image with light emitted from a light source and that includes a photoelectric conversion device for detecting reflection or transmission quantities of the light and for converting the light into an electric signal.

2. Description of the Related Art

Conventional film scanners include those of a type that obtains full color image data in such a manner that rays of light of three primary colors are emitted to irradiate an original image such as a transmissive image formed on, for example, a negative film or a positive film, and an image pick-up device (such as a charge-coupled device (CCD)) reads the transmitted light. For a typical light source employed in the film scanner, for example, halogen lamps, cold cathode tubes, or light emitting diodes (LEDs) are used.

Depending on the film scanner, color separation is performed either on the side of the light source or on the side of the image pick-up device.

In a film scanner performing the color separation on the side of the light source, for example, halogen lamps or LEDs are used as the light source.

Halogen-lamp light includes wavelengths of the three primary colors, and the light can be separated by a color-separating filter into rays of light of the individual colors (R, G, and B colors). The rays of light of the individual colors separated in time series are emitted to irradiate the original image and are individually picked up by an image pick-up device. Image data (density data) corresponding to the individual colors can be thereby obtained. However, in a configuration using the halogen lamps as the light source, a large drive mechanism for the color-separating filter must be provided. In addition, since the halogen lamp generates a large amount of heat, a means of countering the heat generation must be provided. This increases a size of the film scanner.

Moreover, since an LED emits monochromatic light, LEDs which respectively emit light of the three primary colors should be arranged such that light of the three primary colors is emitted evenly in a predetermined region, and the color of the emitted light is sequentially switched to irradiate the original image. When the LEDs are used as the light source, no filter-driving mechanism needs to be provided, and an amount of heat generated thereby is significantly less than in that generated by the halogen lamps. However, the light source must be formed as an aggregate of many single-point light sources to secure light quantity, and a large light diffusion box or the like must be provided to suppress variation in quantity of light. Alternately, if a number of the LEDs is reduced, lack of light-quantity may occur. As a result, miniaturization of the film scanner is thereby limited.

On the other hand, when the color separation is performed at the image pick-up device, cold cathode tubes are usually used as the light source.

The cold cathode tube is basically a light source which emits white light. For this reason, a color-separating filter is disposed over an image pick-up surface of the image pick-up device, in which image data (density data) of the three primary colors are obtained in one image pick-up operation. In this case, while no drive system needs to be provided on the light source side, a sufficient quantity of light can be secured and therefore, enabling miniaturization of the film scanner. However, the stability is insufficient, and a high-voltage circuit needs to be provided for illumination.

As described above, since the individual light sources have advantages and disadvantages, basic specifications that are to be given priority need to be predetermined when designing a film scanner. That is, the film scanner will be deficient in versatility.

### SUMMARY OF THE INVENTION

In view of the circumstances described above, an object of the invention is to provide an image reading apparatus that has a simple construction not requiring a mechanical drive mechanism for switching an emission wavelength, that can uniformly ensure in a predetermined region a quantity of light sufficient for reading an image, and that provides versatility for design specifications, when selecting a light source with which an original image is read out by a photoelectric conversion device.

According to a first aspect of the invention, there is provided an image reading apparatus including a light source which emits light and irradiates the light to an original image, and a photoelectric transducing device for detecting reflected or transmitted quantities of the irradiated light, and for transducing the light into an electric signal, the apparatus including: a surface-emitting electroluminescent device serving as the light source and emitting light of wavelengths corresponding to at least the three primary colors; and a temperature adjusting mechanism for stabilizing a temperature with respect to heat generated by the electroluminescent device.

The image reading apparatus as described above includes the electroluminescent (EL) device of a surface-emitting type that is widely used and that provides a sufficient quantity of light. As such, the EL device can suitably be used as the light source for reading the original image.

In addition, the EL device facilitates electrical control of the emission quantity. As such, independent light sources need not be used depending on whether priority is given to the reading speed or the reading resolution. Consequently, versatileness can be imparted to the image reading apparatus.

Further, since the EL device includes emission lights of wavelengths corresponding to at least the three primary colors, image data can be obtained in the form of data representing a full-color image.

The temperature adjusting mechanism enables suppression of wavelength variations occurable because of heat generated when the EL device emits light. In this case, the temperature varies less than in the conventional case where the cold cathode tube is used as the light source. Consequently, the temperature adjusting mechanism to be used can be small, thereby contributing to the miniaturization of the image reading apparatus.

According to a second aspect of the invention, there is provided an image reading apparatus including a light source which emits light and irradiates the light to an original image, and a photoelectric transducing device for detecting reflected or transmitted quantities of the irradiated light, and for transducing the light into an electric signal, the apparatus including: a surface-emitting electroluminescent device serving as the light source and emitting light of wavelengths corresponding to at least the three primary colors; and a temperature adjusting mechanism for stabilizing a temperature with respect to heat generated by the electroluminescent device; and a switching mechanism for causing the electroluminescent device to emit the light of the individual colors in time series.

As described above, the image reading apparatus includes the switching mechanism for switching the emission light on the side of the light source at the time of reading the original image in a full-color mode. Suppose the light-emissive layer of the EL device is preliminarily divided into, for example, devices for emitting light of R, G, and B colors. In this case, the switching mechanism enables only light of a desired wavelength to easily be emitted by controlling electric conduction to the device corresponding to each of the colors (i.e., no filter needs to be provided to achieve the emission).

According to a third aspect of the invention, there is provided an image reading apparatus including a light source which emits light and irradiates the light to an original image, and a photoelectric transducing device for detecting reflected or transmitted quantities of the irradiated light, and for transducing the light into an electric signal, the apparatus including: a surface-emitting electroluminescent device serving as the light source and emitting light of wavelengths corresponding to at least the three primary colors; and a temperature adjusting mechanism for stabilizing a temperature with respect to heat generated by the electroluminescent device; and a light-quantity equalizing mechanism for equalizing a quantity of light emitted from the electroluminescent device in a predetermined region, the light-quantity equalizing mechanism being provided between the electroluminescent device and the original image.

For example, when a predetermined region is divided into grid sections that emit light of the individual colors, variations in light-quantity can occur. As such, the optical diffuser may be provided to equalize the emission quantity in the predetermined region of the emitting surface of the EL device.

According to a fourth aspect of the invention, there is provided an image reading apparatus including a light source which emits light and irradiates the light to an original image, and a photoelectric transducing device for detecting reflected or transmitted quantities of the irradiated light, and for transducing the light into an electric signal, the apparatus including: a surface-emitting electroluminescent device serving as the light source and emitting light of wavelengths corresponding to at least the three primary colors; and a temperature adjusting mechanism for stabilizing a temperature with respect to heat generated by the electroluminescent device, wherein the wavelengths of the light emitted from the electroluminescent device comprise a wavelength corresponding to infrared light.

The infrared light transmits through, for example, a transmissive original image, regardless of the density of the original image. Hence, variations in the light-quantity occur only at defective portions such as damaged or dust-adhered portions of the transmissive original image. As such, by performing interpolation for the damaged or dust-adhered portions according to peripheral image data after a photoelectrical conversion, influence of the damage or the like can be eliminated from a finished image that is formed according to the image data.

According to a fifth aspect of the invention, there is provided an image reading apparatus including: a light source for irradiating light to an original image; a photoelectric transducing device for detecting reflected or transmitted quantities of the irradiated light, and for transducing the light into an electric signal; and a control mechanism for adjusting an emission region of the light source to a size of the original image; wherein the light source includes a surface-emitting electroluminescent device that emits light of wavelengths corresponding to at least the three primary colors.

According to a sixth aspect of the invention, there is provided an image reading apparatus including: a light source for irradiating light to an original image; and a photoelectric transducing device for detecting reflected or transmitted quantities of the irradiated light, and for transducing the light into an electric signal; wherein the light source includes a surface-emitting electroluminescent device that emits light of wavelengths corresponding to at least the three primary colors, and wherein the wavelengths of the light emitted from the light source comprise a wavelength corresponding to infrared light.

The image reading apparatus according to the sixth aspect may include a control mechanism for adjusting an emission region of the light source to a size of the original image. Conventionally, since a range of irradiation by light emitted from a light source is set constant despite the fact that original images of various sizes are input, a mask needs to be used for an unnecessary peripheral region of the original image by having such a configuration. However, the above-described EL device with the switchable emission region facilitates, corresponding to the size of the original image, emission to irradiate only a necessary region with a necessary quantity of light. In addition, since the emission region is set to conform the size of the original image, occurrence of flare can be prevented, and no mask needs to be used for the original image.

According to a seventh aspect of the invention, there is provided an image reading method using an image reading apparatus, the method including the steps of: (a) conveying an original image to a predetermined position and stopping the original image thereat; (b) driving an electroluminescent device which serves as a light source, and discretely irradiating the original image with light of each of three primary colors; (c) condensing and detecting light that has transmitted through the original image; and (d) transducing density data of the detected light of each of the colors into digital data, and storing the digital data.

According to a eighth aspect of the invention, there is provided a method of manufacturing a light source for an image reading apparatus, the method including the steps of: (a) forming a light-emissive layer for a surface-emitting electroluminescent device; and (b) separately vapor-depositing the light-emissive layer for each of the three primary colors such that the light-emissive layer emits light of each of the three primary colors.

According to a ninth aspect of the invention, there is provided an image reading apparatus including: a light source for irradiating light to an original image; a photoelectric transducing device for detecting reflected or transmitted quantities of the irradiated light, and for transducing the light into an electric signal; and a control mechanism for adjusting an emission region of the light source to a size of the original image; wherein the light source includes a surface-emitting electroluminescent device that emits light of wavelengths corresponding to at least the three primary colors and a surface-emitting electroluminescent device that emits infrared light.

### BRIEF DESCRIPTION OF THE DRAWINGS

FIG. 1 is a perspective view of a film scanner according to an embodiment of the present invention.

FIG. 2 is a schematic structural view of the film scanner according to the embodiment of the invention.

FIG. 3 is a cross-sectional view showing a structure of an organic electroluminescent (EL) device employed as a light source according to the embodiment of the invention.

FIG. 4 is a schematic structural view of a light source according to a second embodiment of the invention, showing a case where separate organic EL devices are included corresponding to each of R, G, and B colors.

FIG. 5 is a flow chart showing an operation to adjust a size of an emission region of the organic EL device to correspond to a size of an original image.

### DESCRIPTION OF THE PREFERRED EMBODIMENT

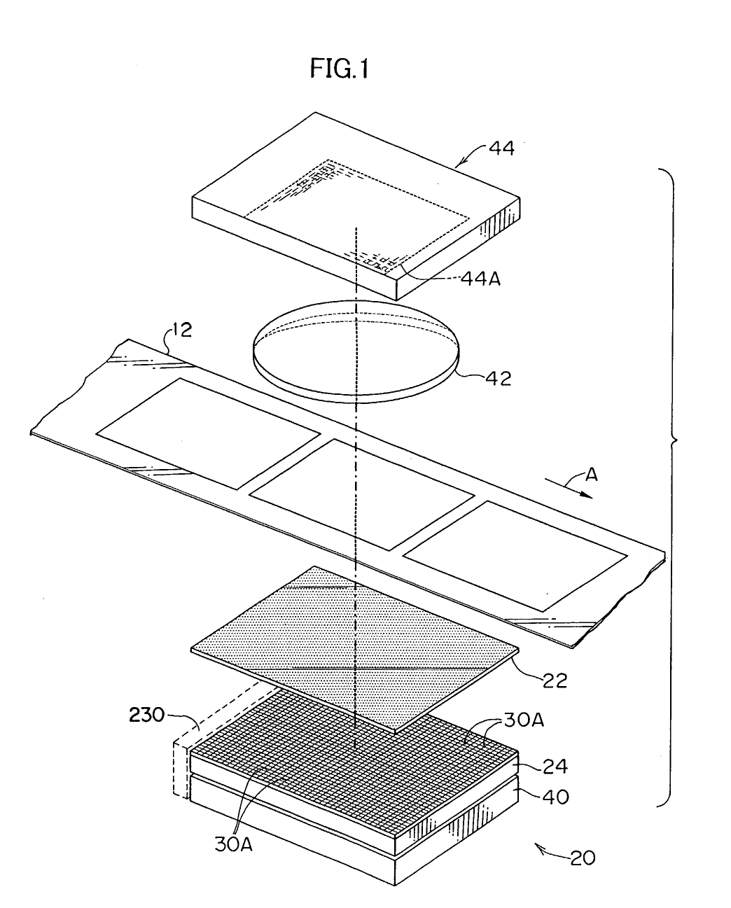

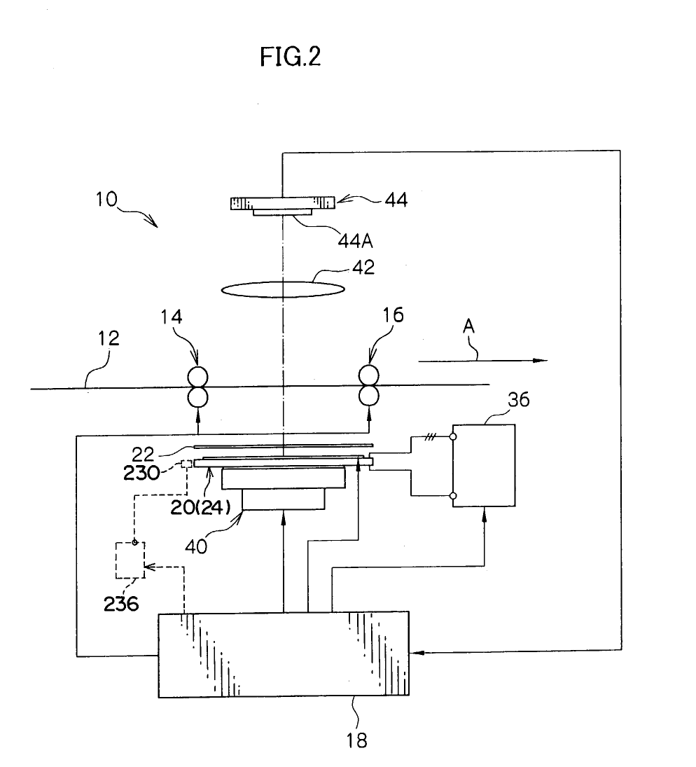

FIGS. 1 and 2 each show an image reading apparatus (film scanner) 10 according to an embodiment of the present invention.

An original image employed in the embodiment is a silver-photography negative film 12 (which hereinbelow will simply be referred to as a negative film). The negative film 12 is inserted into a camera (not shown), photographs are taken, and latent images are then recorded thereon. Thereafter, the negative film 12 is developed by a developing apparatus (not shown). It should be noted that the original image is not limited to the negative film 12, and a different diapositive such as a positive film may be used.

As shown in FIG. 2, the negative film 12 is held substantially horizontal by being nipped between two pairs of conveyance rollers 14 and 16. The conveyance rollers 14 and 16 rotate at the same speed by respectively receiving a drive signal from a controller 18 and thereby convey the negative film 12 in the direction of arrow A shown in FIGS. 1 and 2. It should be noted that the speeds of the conveyance rollers 14 and 16 may be set slightly different from each other (specifically, the rollers at a front side in the conveyance direction may be set slightly faster) or a one-way clutch mechanism may be provided at a rear side in the conveyance direction, to convey the negative film 12 in a tensioned state.

A reading stage is set between the conveyance rollers 14 and 16. A section below the reading stage is an light emission side, and a section above the reading stage is a reading side. A light source 20 and an optical diffuser 22 are disposed at the light emission side. Light emitted from the light source 20 passes through the optical diffuser 22 and then irradiates the negative film 12. Then, the transmitted light that has transmitted through the negative film 12 reaches to the reading side. The optical diffuser 22 concurrently function to protect an emitting surface of the light source 20.

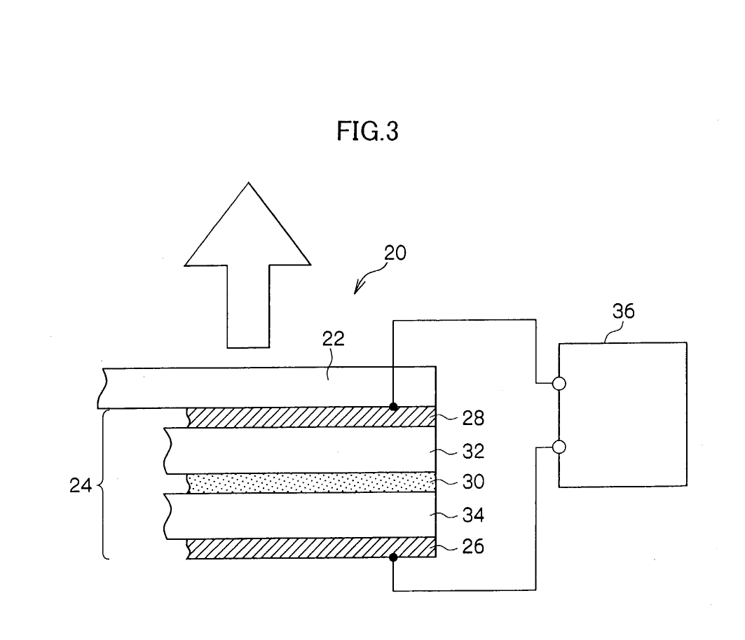

In addition, the embodiment employs an organic electroluminescent (EL) device 24 (see FIG. 3) as the light source 20.

As shown in FIG. 3, the organic EL device 24 is of a self-emitting type device and is structured such that a light-emissive layer 30 is held between a pair of electrodes, i.e., cathode 26 and anode 28. A hole transport layer 32 lies between the anode 28 and the light-emissive layer 30. Further, an electron transport layer 34 lies between the cathode 26 and the light-emissive layer 30. When a predetermined voltage is applied between the anode 28 and the cathode 26 by an emission driver 36 connected to the controller 18, the light-emissive layer 30 emits light of a predetermined wavelength.

The light-emission quantity of the light-emissive layer 30 may be controlled by either current control or pulsewidth-modulation (PWM) control.

In the light source 20 of the embodiment, the light-emissive layer 30 is divided into a grid (in FIG. 1, reference numeral 30A denotes individual sections of the grid schematically shown on a surface of the light source 20) and the light-emissive layer 30 is preliminarily formed such that distribution of light of individual R, C, and B colors is substantially equalized over an entire area of the light-emissive layer. More specifically, the light-emissive layer is separately vapor-deposited for each of the colors in a state in which a metal mask is applied to grid sections 30A corresponding to the same color. It is thereby possible to cause the grid sections to emit light of different colors. Generally, the grid sections 30A can be formed at a pitch of 1 mm or less. However, in the embodiment, since the light is diffused using the optical diffuser 22 to avoid unevenness of the light, the grid sections 30A may be formed at a pitch of several millimeters.

When irradiating the negative film 12 with R-color light, the corresponding grid sections 30A for emitting the R-color light are driven (cause to emit light) so that only the R-color light reaches the optical diffuser 22. Similarly, when irradiating the negative film 12 with either G-color light or B-color light, the corresponding grid sections 30A for emitting either the G-color light or the B-color light are driven (cause to emit light). Thereby, only light of a necessary color can be emitted and reach the optical diffuser 22.

The optical diffuser 22 assumes a role of regulating the emission quantity of the grid sections 30A, which is the part of the light-emissive layer 30. As such, according to the regulation of the optical diffuser 22, the negative film 12 is irradiated with an uniform emission quantity.

A temperature adjusting device 40 is disposed on the backside of the light source 20. The temperature adjusting device 40 includes, for example, a pertier device or the like, and is controlled by a signal from the controller 18. The temperature adjusting device 40 suppresses heat that is generated by the emission from the light source 20. For example, the temperature on the side of the emitting surface is detected in real-time, to perform feedback control thereof, or the temperature is controlled according to the emission time by using a statistical database. Thereby, the temperature of the light source 20 is maintained substantially constant, and wavelength variations ascribable to the temperature can be prevented.

As shown in FIGS. 1 and 2, a condenser 42 is disposed in the reading side and is used to condense light that has transmitted through the negative film 12. A CCD area sensor 44 is disposed to an image-forming surface of the condenser 42, and the density of the transmitted light is detected by a reading section 44A of the CCD area sensor 44.

The CCD area sensor 44 is connected to the controller 18, and an electric signal (representing density data) that is photoelectrically converted is input to the controller 18.

The controller 18 converts the input density data for each of the colors of the negative film 12 into digital data, and stores the digital data therein. The digital data is subjected to various corrective processes, and the corrected digital data is then transmitted to an image recorder (not shown). Thereafter, digital exposure is performed, and an image is formed onto, for example, a photographic printing paper.

Hereinafter, operation of the embodiment will be described.

The negative film 12 on which images have been recorded are nipped between the two pairs of conveyance rollers 14 and 16, and are thereby positioned in units of one image frame to the reading stage.

After positioning of the negative film 12 is completed, an image reading operation is started. The CCD area sensor reads the image in time series (selectively) in units of each of the R, G, and B colors to obtain a full-color image with respect to the image frame. For this reason, the light source 20 is first set to the R-color light.

The embodiment uses the organic EL device 24 as light source 20, in which the light-emissive layer 30 emits light due to a predetermined voltage applied by the emission driver 36 between the anode 28 and the cathode 26. The emission region of the light-emissive layer 30 is divided into the grid sections 30A that emit light of the individual R, G, and B colors, respectively. Accordingly, in the light-emissive layer 30, each divided section 30A emits light in different colors individually. Therefore, to set the light source 20 to the R-color light, the corresponding grid sections 30A for emitting the R-color light are driven (cause to emit light). As a result, only the R-color light reaches the optical diffuser 22.

In the optical diffuser 22, the R-color light emitted in a section of the emission region is diffused to uniform the quantity of the light over the entire emission region.

Since the diffused light irradiates the negative film 12, the uniform quantity of the R-color light is applied to irradiate over the entire region of the image that is to be read.

The R-color light that transmitted through the image of the negative film 12 is condensed by the condenser 42, and is input to the reading section 44A of the CCD area sensor 44. Then, the light incident into the reading section 44A is photoelectrically converted, and an electric signal (voltage) which meets an image density of a component corresponding to the R-color light is transmitted to the controller 18. The controller 18 converts the input electric signal into a digital signal and stores the digital signal as digital image data.

After the image reading operation for the R-color light is completed, a similar reading operation for the G-color light and the B-color light is carried out. At this time, only the driving region of the divided sections 30A should be switched. When the light source 20 is kept in an emitting state, heat is generated. In the embodiment, however, the temperature adjusting device 40 is disposed on the backside of the light source 20, and the temperature is thereby adjusted so that the light source 20 always maintains at a predetermined temperature. Consequently, variations in wavelength due to heat does not occur and a stable image reading operation can be implemented.

When the image reading operations corresponding to each R, G, and B colors is completed, the negative film 12 is conveyed forward by one image frame, and the subsequent image frame is positioned.

As described above, since the embodiment employs the organic EL device 24 as the light source 20, a compact and sufficient emission quantity can be obtained. This enables the image reading apparatus to be miniaturized. In addition, the light-emissive layer 30 is divided into the grid sections 30A that emit light of the individual R, G, and B colors. As such, neither a color-changing member (such as a color separating filter) nor a color-changing drive system needs to be provided.

As described above, the emission quantity of the light source 20 is set constant, and also a dynamic range of the reading operations carried out by the CCD area sensor 44 is set constant. However, it may be modified to pre-scan the negative film 12 at a constant speed and recognize an average value of the density of each image frame during the pre-scan operation, and change the emission quantity of the light source 20 and the dynamic range of the CCD area sensor 44 in each image frame.

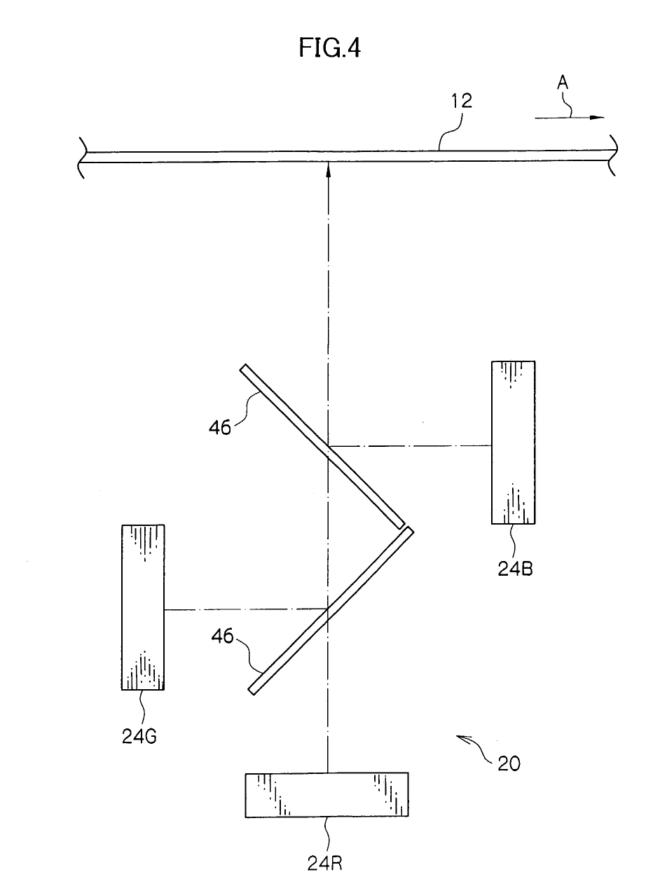

In addition, in the embodiment, the light-emissive layer 30 is divided into the grid sections 30A, which respectively emit the light of the R, G, and B colors. However, as shown in FIG. 4, three organic EL devices 24R, 24G and 24B which respectively emit the light of the R, G, and B colors may be provided, and align the optical axes by dichroic mirrors 46, and alternately irradiate light to the negative film 12. Since the organic EL devices 24R, 24G, and 24B perform surface emission, no optical diffuser is needed.

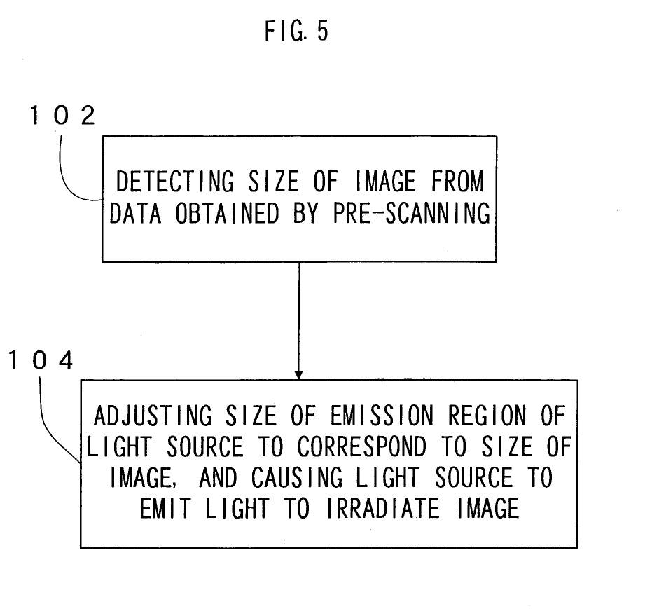

Further, in the embodiment, the emission region of the organic EL device 24 is always constant. However, the emission region may be variably set corresponding to the size of the negative film 12 by controlling the emission driver 36. That is, as specifically shown in FIG. 5, a step 102 to detect the size of the negative film 12 (i.e., the original image) is included while carrying out the above-described pre-scan operation, and in a step 104, the emission region of the organic EL device 24 is adjusted and set to the size of the negative film 12 so that the light which is emitted from the organic EL device 24 and which irradiates the negative film 12 corresponds to the size of the negative film 12. This leads to energy saving and enables the prevention of flare even without masking the negative film 12.

Further, in addition to the regions of the emission colors, namely, the R, G, and B colors, for the image reading operations, an infrared ray emitting region for detecting film defects may be provided within the organic EL device 24. The quantity of light of the infrared ray does not depend on the image density of the negative film 12 when the infrared ray transmits through an image formed on the negative film 12, but only varies at defective portions such as damaged or dust-adhered portions. As such, after the read image is converted into digital image data by the controller 18, the defective portion is interpolated based on the peripheral image data, and the damage can be eliminated from the finished image printed on a photographic printing paper or the like. Consequently, the quality of the output image can be improved.

Furthermore, although the embodiment utilizes the organic EL device 24 as the light source 20, an inorganic EL device may be utilized. Since the inorganic EL device has a significantly long service life in comparison to the organic EL device, it is advantageous in terms of maintainability.

Further, a filter may be inserted according to the variable spectral characteristics of the type of the negative films 12 to attenuate light of unnecessary wavelengths. Thereby, accuracy of the reading operation can be improved.

Furthermore, the grid sections 30A that partly constructs the light source 20 may be omitted, and the light source may be utilized to serve as a white light source, and color separation may be performed through a filter on the CCD area sensor 44 side. In comparison to the conventional cold cathode tube used as the white light source, the organic EL device 24 (or an inorganic EL device) is more effective to enhance luminous efficiency.

Moreover, not only may a single organic or inorganic EL device be utilized as the light source 20, but other types of light sources may be used in combination therewith. For example, an infrared-ray emission source for damage elimination may be formed by a different light source as a supplemental light source 230, as shown in FIGS. 1 and 2 by doted lines. It should be noted that the supplemental light source 230 may also emit infrared-rays at an emission region of a size that is adjusted to correspond to the size of the original image obtained in the pre-scanning operation described above. Alternatively, LEDs, halogen lamps, or the like may be provided as a supplementary light source for use in the event that light quantity becomes deficient, and may be used when necessity arises.

Further, the position of the reading side may be used as the emission side. Thereby, the reader can be used not only for the transmissive original but also for a reflective original.

As described above, the present invention has a simple construction that does not require a mechanical drive mechanism to switch the wavelength of an emitted light in selection of a light source with which an original image is read by a photoelectric conversion device, and can insure a light quantity sufficient for reading an image in a predetermined region, and that enables versatileness to be provided for design specifications.

What is claimed is:

1. An image reading apparatus including a light source which emits light and irradiates the light to an original image, and a photoelectric transducing device for detecting reflected or transmitted quantities of the irradiated light, and for transducing the light into an electric signal, the apparatus comprising:
a surface-emitting electroluminescent device serving as the light source and emitting light of wavelengths corresponding to at least the three primary colors; and
a temperature adjusting mechanism for stabilizing a temperature with respect to heat generated by the electroluminescent device.

2. An image reading apparatus including a light source which emits light and irradiates the light to an original image, and a photoelectric transducing device for detecting reflected or transmitted quantities of the irradiated light, and for transducing the light into an electric signal, the apparatus comprising:
a surface-emitting electroluminescent device serving as the light source and emitting light of wavelengths corresponding to at least the three primary colors; and
a temperature adjusting mechanism for stabilizing a temperature with respect to heat generated by the electroluminescent device; and
a switching mechanism for causing the electroluminescent device to emit the light of the individual colors in time series.

3. An image reading apparatus including a light source which emits light and irradiates the light to an original image, and a photoelectric transducing device for detecting reflected or transmitted quantities of the irradiated light, and for transducing the light into an electric signal, the apparatus comprising:
a surface-emitting electroluminescent device serving as the light source and emitting light of wavelengths corresponding to at least the three primary colors; and
a temperature adjusting mechanism for stabilizing a temperature with respect to heat generated by the electroluminescent device; and
a light-quantity equalizing mechanism for equalizing a quantity of light emitted from the electroluminescent device in a predetermined region, the light-quantity equalizing mechanism being provided between the electroluminescent device and the original image.

4. An image reading apparatus including a light source which emits light and irradiates the light to an original image, and a photoelectric transducing device for detecting reflected or transmitted quantities of the irradiated light, and for transducing the light into an electric signal, the apparatus comprising:
a surface-emitting electroluminescent device serving as the light source and emitting light of wavelengths corresponding to at least the three primary colors; and
a temperature adjusting mechanism for stabilizing a temperature with respect to heat generated by the electroluminescent device,
wherein the wavelengths of the light emitted from the electroluminescent device comprise a wavelength corresponding to infrared light.

5. An image reading apparatus comprising:
a light source for irradiating light to an original image;
a photoelectric transducing device for detecting reflected or transmitted quantities of the irradiated light, and for transducing the light into an electric signal; and
a control mechanism for adjusting an emission region of the light source to a size of the original image;
wherein the light source includes a surface-emitting electroluminescent device that emits light of wavelengths corresponding to at least the three primary colors.

6. The image reading apparatus according to claim 5, further comprising a switching mechanism for causing the light source to selectively emit the light of the individual colors.

7. The image reading apparatus according to claim 6, further comprising a temperature adjusting mechanism for stabilizing a temperature of the light source.

8. The image reading apparatus according to claim 5, further comprising a light-quantity equalizing mechanism for equalizing a quantity of light emitted from the light source in a predetermined region, the light-quantity equalizing mechanism being provided between the light source and the original image.

9. The image reading apparatus according to claim 8, wherein the light-quantity equalizing mechanism comprises an optical diffuser.

10. The image reading apparatus according to claim 6, wherein the wavelengths of the light emitted from the light source comprise a wavelength corresponding to infrared light.

11. The image reading apparatus according to claim 6, wherein the light source comprises grid sections divided so as to correspond to at least the three primary colors.

12. The image reading apparatus according to claim 6, wherein the light source emits white light and further comprises a filter for performing color separation of the white light into the three primary colors.

13. The image reading apparatus according to claim 6, wherein the light source comprises at least three electroluminescent devices for discretely emitting light of the three primary colors.

14. The image reading apparatus according to claim 5, wherein the light source comprises an organic electroluminescent device.

15. The image reading apparatus according to claim 5, wherein the light source comprises an inorganic electroluminescent device.

16. An image reading apparatus comprising:
a light source for irradiating light to an original image; and
a photoelectric transducing device for detecting reflected or transmitted quantities of the irradiated light, and for transducing the light into an electric signal;
wherein the light source includes a surface-emitting electroluminescent device that emits light of wavelengths corresponding to at least the three primary colors, and wherein the wavelengths of the light emitted from the light source comprise a wavelength corresponding to infrared light.

17. The image reading apparatus according to claim 16, further comprising a control mechanism for adjusting an emission region of the light source to a the size of the original image.

18. An image reading method using an image reading apparatus, the method comprising the steps of:
(a) conveying an original image to a predetermined position and stopping the original image thereat;
(b) driving an electroluminescent device which serves as a light source, and discretely irradiating the original image with light of each of three primary colors;
(c) condensing and detecting light that has transmitted through the original image; and
(d) transducing density data of the detected light of each of the colors into digital data, and storing the digital data.

19. The image reading method according to claim 18, further comprising a step of irradiating the original image with infrared light.

20. The image reading method according to claim 19, further comprising a step of performing optical diffusion so that a quantity of light irradiated to the original image is equalized before the light transmits through the original image.

21. A method of manufacturing a light source for an image reading apparatus, the method comprising the steps of:
(a) forming a light-emissive layer for a surface-emitting electroluminescent device; and
(b) separately vapor-depositing the light-emissive layer for each of the three primary colors such that the light-emissive layer emits light of each of the three primary colors.

22. An image reading apparatus comprising:
a light source for irradiating light to an original image;
a photoelectric transducing device for detecting reflected or transmitted quantities of the irradiated light, and for transducing the light into an electric signal; and
a control mechanism for adjusting an emission region of the light source to a size of the original image;
wherein the light source includes a surface-emitting electroluminescent device that emits light of wavelengths corresponding to at least the three primary colors and a surface-emitting electroluminescent device that emits infrared light.
